(19) United States
(12) Patent Application Publication
(10) Pub. No.: US 2009/0206231 A1
(43) Pub. Date: Aug. 20, 2009

(54) Adjustable equipment assembly and base therefor

(76) Inventors: Steven Andrew Firman, Pointe-Claire (CA); Basil Katsivalis, Pointe-Claire (CA)

Correspondence Address: Franz BONSANG;c/o EQUINOX PROTECTION, 410 - 1500, Du College, St-Laurent, QC, H4L 5G6, CA

(21) Appl. No.: 12/071,182

(22) Filed: Feb. 19, 2008

(51) Int. Cl. F16M 11/24

(52) U.S. Cl. 248/677; 248/678

(57) ABSTRACT

An equipment assembly includes an equipment base, a equipment top adapted for use as equipment by a user, and a retaining means for retaining the equipment top and the equipment base connected to one another. Legs mounted in a support base of the equipment base provide for easy leveling of the equipment top and the position of the equipment top relative the equipment base. The assembly may be deployed in a variety of environments, including a liquid environment. Weighting elements disposed in the equipment base serve to anchor the equipment assembly.

### FIELD OF THE INVENTION

The present invention relates to equipment, and is more particularly concerned immersible and adjustable equipment and a therefor.

### BACKGROUND OF THE INVENTION

Immersible and adjustable equipment, such as furniture or sporting equipment, as well as kits and assemblies providing such, are well known in the art. For example, U.S. patent application Ser. No. 09/748,899, filed by Shinn on Dec. 27, 2000 and published on Jun. 5, 2003, teaches an adjustable equipment assembly for table furniture which provides a table furniture, or equipment, top telescopically mounted on an equipment base, the equipment top essentially providing a table top. The base is set on a support surface and supports the equipment top thereabove. As the equipment top is telescopically mounted on the equipment base, height of the table, and notably the equipment top, may be readily adjusted. However, the furniture equipment taught by Shinn does not appear to be readily immersible and usable in water or another liquid. Further, the furniture disclosed by Shinn does not appear to provide any mechanism for leveling the equipment top when the base is rested on an uneven support surface. Additionally, the pneumatic mechanism for adjusting the height of the equipment top is unnecessarily complex.

U.S. Pat. No. 5,644,873, issued to Bourgault on Jul. 8, 1997, discloses immersible equipment, namely stairs, for use in an environment, such as a swimming pool, wherein the support surface upon which the equipment rests is below a liquid surface of a body of liquid, such as water. While the equipment taught by Bourgault is readily immersed and maintained on the surface by a weighting or ballast element, such as sand bags, it is not readily adjustable in height above the support surface and does not appear to have any means for easily leveling the equipment when the equipment surface is uneven.

Accordingly, there is a need for an improved equipment assembly and equipment base therefor.

### SUMMARY OF THE INVENTION

It is therefore a general object of the present invention to provide improved an improved equipment assembly for providing equipment and an equipment base therefore for supporting the equipment assembly on a surface.

An advantage of the present invention is that the equipment provided thereby is easily adjustable in height relative a support surface upon which the equipment base rests.

Another advantage of the present invention is that the equipment base and equipment top of the assembly connected thereto can easily be leveled, even when the equipment base is situated on an uneven support surface.

A further advantage of the present invention is that the equipment assembly can be easily immersed and used in a liquid environment, with the support surface on which the assembly rests situated below a liquid surface of the liquid.

Still another advantage of the present invention is that the equipment top is removably attachable to the equipment base and may be changed from one type of equipment top, such as a stool seat or table top, to an another type of equipment top, such as a sport equipment top to provide, for example, sporting equipment such a net pole, basketball net, or the like.

Another advantage of the present invention is that the equipment top may be raised and lowered on the equipment base to adjust the height of the equipment top relative a support base of the equipment base and a support surface upon which the support base is situated.

Other objects and advantages of the present invention will become apparent from a careful reading of the detailed description provided herein, with appropriate reference to the accompanying drawings.

In one aspect, the present invention provides an equipment base for supporting an equipment top connectable thereto, the equipment top having an equipment portion adapted for use as equipment by a user connectable thereto, above a surface upon which the equipment top is placed, the equipment base comprising:
a support base having a top side to which the equipment top is connectable and a generally opposed bottom side;
a plurality of channels extending through the support base from the top side to the bottom side and substantially equally spaced apart relative one another proximal a perimeter defined by the support base of the base, and a respective leg adjustably mounted in each channel, each leg having a first end proximal the top side and a second end proximal the bottom side, wherein each the leg is adjustably raisable and lowerable in the respective channel for raising and lowering the base relative the support by extension and retraction of the leg in contact with the support surface for adjusting tilt of the support base relative thereto and leveling of the equipment portion relative thereto, when the equipment top is connected to the equipment base and the support base is set on the support surface.

In another aspect, there is provided an equipment assembly comprising:
an equipment top having an equipment portion adapted for use as equipment by a user and a circular threaded top socket disposed substantially normal to the equipment portion and having two generally opposed socket apertures extending longitudinally on an internally threaded portion of a socket wall thereof; and
an equipment base for placement on a support surface and connectable to the equipment top for supporting the equipment top on the support surface, the equipment base comprising:
   a support base having a top side with a base member extending substantially normally therefrom and rotatingly insertable in the top socket to connect the equipment top and the support base, a bottom side, a plurality of channels extending therethrough from the top side to the bottom side and substantially equally spaced apart relative one another proximal a perimeter of the support base, and a respective leg adjustably mounted in each channel, each leg having a first end proximal the top side and a second end proximal the bottom side; and
   a retainer assembly for retaining the base member in the top socket, wherein each the leg is adjustably raisable and lowerable in the respective channel for raising and lowering the base relative the support surface by extension and retraction of the leg in contact with the support surface for adjusting tilt of the support base relative thereto and leveling of the equipment portion when the equipment top is connected to the base and the support base is set on the support surface.

Other objects and advantages of the present invention will become apparent from a careful reading of the detailed description provided herein, with appropriate reference to the accompanying drawings.

### BRIEF DESCRIPTION OF THE DRAWINGS

Further aspects and advantages of the present invention will become better understood with reference to the description in association with the following Figures, in which similar references used in different Figures denote similar components, wherein:

FIG. 1 is a perspective view of an embodiment of an equipment assembly and equipment base therefor in accordance with an embodiment of the present invention;

FIG. 1a is a perspective view of an embodiment an equipment assembly in accordance with the present invention showing an alternative equipment base therefore;

FIG. 2 is a sectional view of the equipment assembly taken along line 2-2 of FIG. 1; and

FIG. 3 is a view similar to FIG. 2 of an equipment assembly in accordance with an alternative embodiment of the present invention.

### DETAILED DESCRIPTION OF THE PREFERRED EMBODIMENTS

With reference to the annexed drawings the preferred embodiments of the present invention will be herein described for indicative purpose and by no means as of limitation.

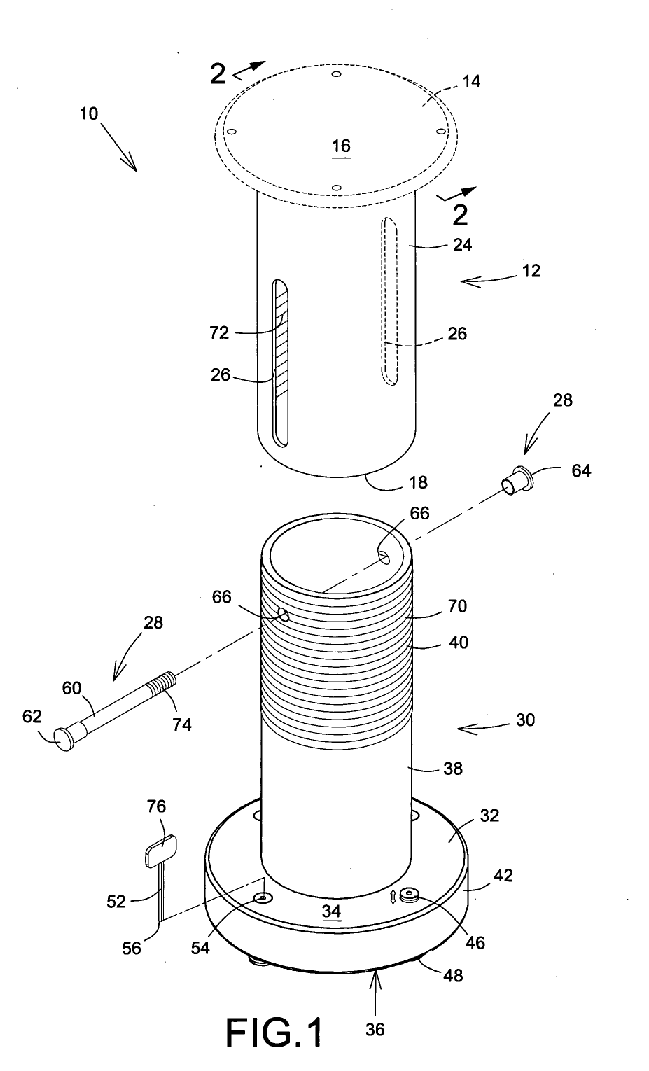

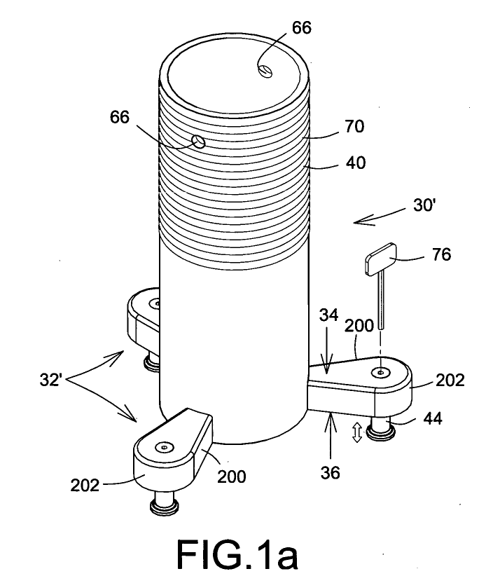

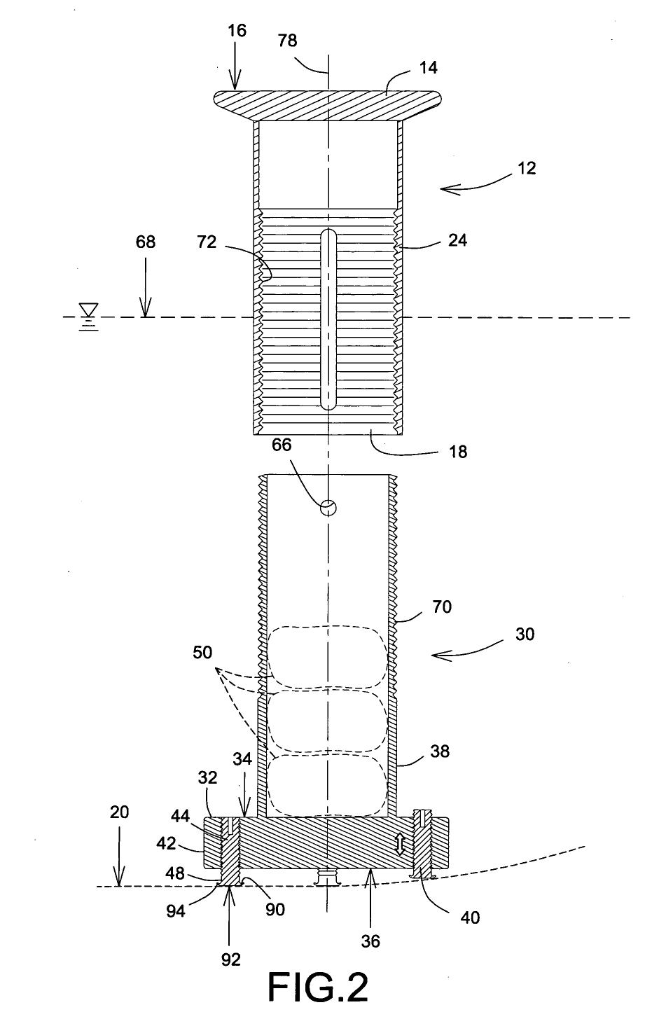

Referring now to FIGS. 1 and 2, therein is shown an equipment assembly, shown generally as 10. The equipment assembly 10 includes an equipment base therefor, shown generally as 30, as well as a equipment top 12, which has a equipment portion 14 adapted for use as equipment, such as furniture or sports equipment, and a preferably circular and threaded top socket 18, disposed, preferably substantially normally, i.e. at approximately 90 degrees, therebelow. The top socket 18 connects the equipment top 12 either directly or indirectly to the equipment base 30. For example, and as shown, the top socket 18 may be disposed within, and defined by, circularly shaped socket walls 24 extending substantially normally from the equipment portion 14 and having two generally opposed and aligned longitudinal socket apertures 26, preferably of identical dimension. However, the top socket 18 may be any socket, and have any orientation relative the equipment portion 14, by which the equipment top 12 may be connected to the equipment base 18 and raised and lowered in relation thereto. The retaining means or assembly, shown generally as 28, retains the equipment top 12 and equipment base 30 connected to one another.

The equipment portion 14 may, for example and as shown, include a flat user surface 16 suitable for use as a table, shelf, or stool. However, the equipment portion 14 may be or include any structure suitable for use as equipment mounted and supported on a support surface 20 by the equipment base 30, and which is connectable either directly or indirectly thereto. For example, the equipment portion could be a structure suitable for use as sports equipment, such as a pole for holding a net, a basketball net, or the like. The equipment portion 14 may also be detachable from the top socket 18. Accordingly, the equipment base 30 and equipment top 12 may be provided together or separately from one another. Alternatively, the entire equipment assembly 10, including the equipment base 30 and the equipment top 12, could be provided together, for example as a kit.

To aid the reader in better understanding the specific features of the invention, the equipment base 30 is now described in greater detail. The equipment base 30 has a support base 32 having a generally opposed base top side 34 and base bottom side 36. The base bottom side 36 is preferably flat and faces a support surface 20 upon which the equipment base 30 is placed, for example set or seated by a user, to support the equipment top 12 when connected thereto. A preferably hollow base member 38, preferably elongate and cylindrical in shape, of the equipment base 30 is disposed substantially normal to the support base 32, and extends, preferably substantially normally, upwardly therefrom, notably from the base top side 34. In order to provide sufficient mass to the equipment base 30 to anchor the equipment base 30, with the equipment top 12 connected thereto, resting on the support surface 20, the base member 30 is preferably configured 44 for receiving and housing at least one ballast or weighting element 50, which may include, for example, bags of sand, metal weights, or any other material suitable for use in the environment in which the equipment base 30 and equipment top 12 are to be used. The support base 32, and in particular the base bottom thereof 36, is preferably sized and shaped to provide sufficient distribution and balance of the mass of the equipment top 12 and the weighting elements 50 to impede accidental upset of the equipment assembly 10 in the environment in which it is deployed.

A plurality of, preferably cylindrical and preferably internally threaded, channels 40 extend through the support base 32 from the base top side 34 to the base bottom side 36. The channels 40 are spaced apart, preferably at substantially equal distance relative one another, around the support base 32, preferably in proximity to a perimeter 42 thereof. For each channel 40, there is a, preferably cylindrical and threaded, channel member or leg 44. The leg 44 is adjustably disposed, for example rotatingly screwed into or mounted, in the channel 40 therein such that a first end 46 of the leg 44 is situated generally proximal the base top side 34 and a generally opposed second end 48 of the leg 44 is proximal the base bottom side 36, preferably extending outwardly thereof. By using an adjustment means 52, adapted along with the first end 46 for rotating the leg 44 in the channel 40, each leg 44 may be adjustably raised and lowered therein such that the second end 48 extends out of the base bottom side 36 to rest on the support surface 20 and support a portion of the support base 32 at an adjustable distance thereabove. By raising and lowering one or more of the legs 44 in this fashion, the tilt of the support base 32 relative the support surface 46 when set thereon and supported by at least one of the legs 44 can be adjusted to level the equipment top 12 when connected to the equipment base 30 seated on the support surface 20. Thus, the equipment top 12 can, advantageously, be leveled when connected to the equipment base 30, even when the support surface 20 upon which the equipment base 30 rests is not itself level.

The adjustment means 12 is preferably an adjustment member 52 having an adjustment end 56 sized and shaped for mating engagement in an adjustment socket 54 disposed on the first end 46 thereof. A curved end 76 of the adjustment member 52, generally opposed the adjustment end 56 and curved or otherwise disposed at an angle of approximately 90 degrees relative the rest of the member 52, facilitates turning of the member 52 when the adjustment end 56 is engaged in the adjustment socket 54 for rotating the member 52 in the channel 40 to raise and lower the member 52 to effect leveling of the equipment assembly 10. For example, and as shown, the adjustment member 52 could be a conventional Allen key 52, with the adjustment socket 54 and adjustment end 56 being hexagonal in shape.

The base member 30 and equipment top 12 are adjustably and removably connected together, for the embodiment shown in FIGS. 1 and 2, by mating insertion and engagement of the base member 38 into the top socket 18. More specifically, the top socket 18 is placed on the base member 38 such that a base member threaded portion 70, generally opposite the support base 32 is engaged with, i.e. introduced into, an internal threaded portion 72 of the top socket 18. The equipment top 12 and base member 38 can then be rotated, or screwed, relative one another about a base member axis 78 defined by the base member 38 to move the equipment top 12 up and down on the base member 38. Accordingly, the position of the equipment top 12, and specifically the equipment portion 14, relative the support base 32, and the support surface 20 when the equipment base 30 is placed thereon, may be readily adjusted.

To retain the equipment top 12 on the base member 12 in a desired position relative the support base 32, or proximal to such a desired position, to equipment top 12 is rotated slightly to align the side apertures with two generally opposed retaining apertures 66 disposed on the base member threaded portion 70 with the socket apertures 26. A retaining means or assembly 28 is then engaged in the apertures 28, 66 to retain the equipment top 12 connected to the equipment base 30 in the desired position. For example, and as shown, the retaining assembly may be a retaining bolt or member 60 sized and shaped for extension through the apertures 26, 66 by insertion of a threaded retaining member portion 74 of the member therethrough until the threaded retaining member portion 74 extends out of one of the socket apertures 26 with the head 62 of the member 60 extending out of the opposing socket aperture 26. The retaining member cap or nut 64 is then screwed onto the threaded retaining member portion 74. To change the position of the equipment top 12 or to remove the equipment top 12 from the equipment base, the nut 64 is simply unscrewed from the bolt 60 and the bolt 60 withdrawn from the apertures 26, 66, allowing the equipment top to be rotated to a new position or removed. If desired the retaining apertures 26 may also be threaded. It should be noted that any other means or mechanism capable of retaining the equipment top 12 and the equipment base 30 connected together with the equipment top 12 at a desired position may be deployed as the retaining means or assembly. Advantageously, weighting elements 50 can be added or removed prior to connecting the equipment top 12 to the equipment base 30, or by simply removing the equipment top 12 as just described, and reconnecting the top 12.

Depending on the material of which the equipment base 30, equipment top 16, and weighting elements 50 are constructed, as well as the size of the equipment base 30 and equipment top 12, the equipment assembly 10 may be used for a variety of applications in a variety of environments. For example, the equipment assembly 10 could be used in a standard outdoor environment, such as on a lawn or a patio, or an indoor environment, such as in a room, where the equipment assembly 10 is not immersed. In such cases, the assembly 10 could be constructed of a variety of materials, such as metal, plastics, or a combination thereof.

Additionally, the equipment assembly 10 could be deployed in an immersed environment, such as a swimming pool, beach, or bath tub. In such environments, the support surface 20 would typically be situated below a liquid surface 68 of a liquid, such as water, in which equipment assembly 10, set on the support surface 20 would be at least partially immersed in the liquid. For liquid environments, the equipment base 30, equipment top 12, and retaining member 62 and nut 64 are preferably made of a sturdy lightweight plastic, which may be buoyant in the liquid. By placing of the weighting elements 50 in the base member 38, for example a plurality of bags of sand, the equipment base 30 can be solidly anchored by the mass thereof, on the support surface 20, with the equipment top 12 connected thereto. Thus the weighting elements 50 can act as ballast in the liquid environment to overcome buoyancy of assembly 10. As an example of the use of the equipment assembly 10 in a liquid environment, the equipment assembly 10 could be deployed in a shallow pool of approximately three feet in depth, i.e. between the support surface 20 and the liquid surface 68. The equipment base 30 could be approximately 23 inches in height with the support base 32 being 14 inches in diameter, and the base member threaded portion 70 10 inches in height. The internal threaded portion 72 of the equipment top 12 would, preferably, be about 11 inches in height, with the base member 38 and socket 24 being between 8 and 8.5 inches in diameter. Given these dimensions, and notably the height of portions 70, 72, the equipment base can easily be set on the support surface 20, the weighting elements 50 placed therein, and the equipment top 12 subsequently connected thereto such that the equipment portion 14, notably the user surface 16 is situated above the liquid surface 68.

Advantageously, regardless of the environment in which the equipment assembly 10 is deployed, use of the adjustment means 52 allows for adjustment of the legs 44 to adjust the tilt and level the equipment top 12, as previously described, with a minimum of effort. At the same time, the height or position of the equipment top 12 can be easily adjusted by rotation thereof relative the base member 38, without resorting to complex pneumatic devices or, depending on the height of the equipment assembly, excessive bending or leaning over of a person adjusting the position of the equipment top 12.

Optionally, and as shown, the second end 48 of each leg may have a leg base or foot 90 extending radially therearound, with each foot providing a substantially flat foot surface 92. When such feet 90 are present, it is the foot surface 92 that rests on the support surface 20. The foot 90 is preferably constructed of a soft rubber or soft rubberized polymer, for minimizing risk of damage to the support surface 20, and which is adapted to prevent slippage on the support surface 20. Accordingly, such feet 20 are particularly useful in liquid environments, such as swimming pools, which may have linings or the like for which tears must be avoided. Similarly, to reduce risk of damage to walls or the like that may extend upwardly from the support surface 20 when the support base 32 is situated proximal thereto, each foot may have an upwardly curving lip 94 curving upwardly away from the foot surface 92. Further, the circular shape of the support base 32, having no corners, also minimized risk of damage to the support surface 20, walls extending upwardly therefrom, or other structures situated proximal the support base 32.

It is important to note that other shapes are possible for the support base 32 of the equipment base 30. For example, and as shown in FIG. 1a, the equipment base 30′ could have a support base 32′ that consists of a plurality, and preferably at least three, support arms 200 having top and bottom sides, respectively 34 and 36, and from which the base member 38 extends substantially normally therefrom, with the base member 38 interconnecting the arms 200. The support arms 200 are preferably substantially equally spaced apart relative one another and extend radially from the base member 38. As with support base 32 shown in FIG. 1, the alternative support base 32′ has channels 40 with channel members or legs 44 disposed therein for adjusting tilt of the support base 32′, with the channels also being preferably equally spaced apart relative one another in proximity to a perimeter defined by the outer ends 202 of the legs. Besides the difference in form, the support base 32′ shown in FIG. 1a maintains all of the features and functionality of the support base 332 shown in FIG. 1.

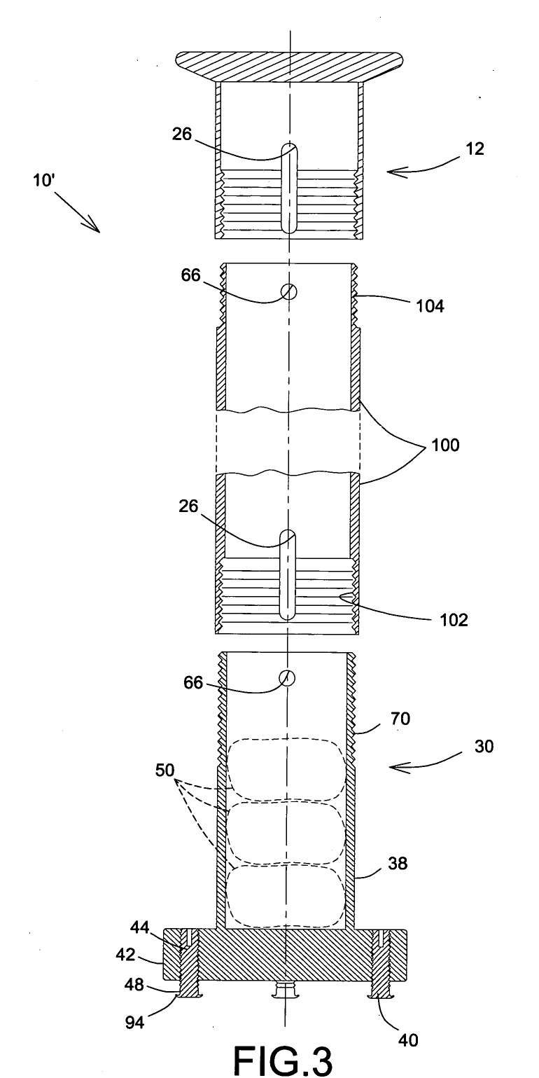

It should be noted that the equipment base 30 and equipment top 12 shown are for purposes of example only. In particular, the equipment top 12, and in particular the equipment portion 14 thereof, may be modified from that shown to provide any number of structures commonly used as furniture. Further, and referring now to another embodiment of the equipment assembly 10′ shown in FIG. 3, an intermediate member 100 having a threaded intermediate member socket 102 and an intermediate member threaded portion 104 may be deployed, along with retaining assembly 28 and apertures 26, 66 to connect the equipment top 12 to the equipment base 30. Finally, it should also be noted that the assembly 10′, 10, or the equipment base 30 alone could be provided as a kit, including the adjustment means 28, if desired. Additionally, the top socket 18 and base member 38 could also be removably connectable to, respectively, the equipment portion 14 and the support base 32, 32′. For example, the top socket 18 and base member 38 could be removably screwed into, respectively, the equipment portion 14 and the support base 32, 32′.

Although the present invention has been described with a certain degree of particularity, it is to be understood that the disclosure has been made by way of example only and that the present invention is not limited to the features of the embodiments described and illustrated herein, but includes all variations and modifications within the scope and spirit of the invention as hereinafter claimed.

We claim:

1. An equipment base for supporting an equipment top connectable thereto, the equipment top having an equipment portion adapted for use as equipment by a user connectable thereto, above a surface upon which the equipment top is placed, the equipment base comprising:
a support base having a top side to which the equipment top is connectable and a generally opposed bottom side;
a plurality of channels extending through the support base from said top side to said bottom side and substantially equally spaced apart relative one another proximal a perimeter defined by said support base of said base, and a respective leg adjustably mounted in each channel, each leg having a first end proximal said top side and a second end proximal said bottom side, wherein each said leg is adjustably raisable and lowerable in said respective channel for raising and lowering said base relative the support by extension and retraction of the leg in contact with the support surface for adjusting tilt of the support base relative thereto and leveling of the equipment portion relative thereto, when the equipment top is connected to the equipment base and the support base is set on the support surface.

2. The equipment base of claim 1, wherein said support base is substantially circular in shape and said channels are circumferentially spaced around said base.

3. The equipment base of claim 1, further comprising a base member extending substantially normally from said top side and configured for connection to said equipment top.

4. The equipment base of claim 3, further comprising at least one weighting element for providing additional mass to said equipment base, wherein said base member is hollow and is configured for housing of said at least one weighting element.

5. The equipment base of claim 4, wherein said equipment base is adapted for use in a liquid environment in which the support surface is situated below a liquid surface of a liquid in which said equipment base is at least partially immersed, said weighting element anchoring said equipment base on said support surface.

6. The equipment base of claim 4, wherein said at least one weighting element comprises a bag of sand.

7. The equipment base of claim 1, wherein each said second end has a respective foot extending radially therefrom, said respective foot having a substantially flat foot surface facing away from said bottom side.

8. The equipment base of claim 7, wherein each said foot has an upwardly curving lip extending from said foot surface upwardly away towards said bottom side.

9. The equipment base of claim 7, wherein each said foot is made from a soft rubber polymer adapted to prevent slippage on the support surface.

10. The equipment base of claim 1, wherein each said channel and each said leg are threaded, said leg being raised and lowered in said channel by rotation of said leg at said first end thereof with an adjustment means.

11. The equipment base of claim 10, wherein each said first end has an adjustment socket, said adjustment means being insertable into said adjustment socket for rotating said leg.

12. The equipment base of claim 3, wherein said base member is adjustably connectable to said equipment top for adjusting a vertical position of said support base and base member base relative said equipment top.

13. The equipment base of claim 3, wherein said base member is removably connected to said support base.

14. The equipment base of claim 1, wherein said support base comprises a plurality of arms extending radially from a base member which extends substantially normally away therefrom, said arms being substantially equally spaced apart and each said arm having a respective said channel and leg disposed therein.

15. An equipment assembly comprising:
an equipment top having an equipment portion adapted for use as equipment by a user and a circular threaded top socket disposed substantially normal to said equipment portion and having two generally opposed socket apertures extending longitudinally on an internally threaded portion of a socket wall thereof; and
an equipment base for placement on a support surface and connectable to said equipment top for supporting said equipment top on said support surface, said equipment base comprising:
a support base having a top side with a base member extending substantially normally therefrom and rotatingly insertable in said top socket to connect said equipment top and said support base, a bottom side, a plurality of channels extending therethrough from said top side to said bottom side and substantially equally spaced apart relative one another proximal a perimeter of said support base, and a respective leg adjustably mounted in each channel, each leg having a first end proximal said top side and a second end proximal said bottom side; and
a retainer assembly for retaining said base member in said top socket, wherein each said leg is adjustably raisable and lowerable in said respective channel for raising and lowering said base relative said support surface by extension and retraction of said leg in contact with said support surface for adjusting tilt of said support base relative thereto and leveling of said equipment portion when said equipment top is connected to said base and said support base is set on said support surface.

16. The equipment assembly of claim 15, further comprising at least one weighting element for providing additional mass to said equipment assembly, wherein said base member is hollow and is configured for insertion of said at least one weighting element and housing said at least one weighting element.

17. The equipment assembly of claim 16, wherein said equipment assembly is adapted for use in a liquid environment in which said support surface is situated below a liquid surface of a liquid in which said equipment assembly is at least partially immersed, said weighting element anchoring said base on said support surface.

18. The equipment assembly of claim 16, wherein said at least one weighting element comprises a bag of sand.

19. The equipment assembly of claim 15, wherein said equipment base and said top socket are constructed of a rigid plastic.

20. The equipment assembly of claim 15, wherein each said channel and each said leg are threaded, said leg being raised and lowered in said channel by rotation of said leg at said first end thereof with an adjustment means.

21. The equipment assembly of claim 15, wherein said base member has a base member threaded portion situated generally opposite said base and having two generally opposed retaining apertures disposed on said base member threaded portion and configured for rotating engagement in said top socket with said equipment top being rotatable on said base portion to raise and lower said equipment top into a desired position relative said base in which said retaining apertures are aligned with said socket apertures, said retainer assembly comprising a retaining member having a retaining member threaded portion and a threaded retaining member cap adapted for rotating and removable connection to said retaining member threaded portion, said retaining member being insertable through said socket apertures and said retaining apertures when aligned for attachment of said retaining member cap to said retaining member threaded portion to retain said equipment top connected to said base member at said desired position.

22. The equipment assembly of claim 15, wherein said equipment portion is one of an equipment top usable as furniture and a sporting equipment top usable as sporting equipment.
